(19) United States
(12) Patent Application Publication
(10) Pub. No.: US 2015/0354284 A1
(43) Pub. Date: Dec. 10, 2015

(54) POLYCRYSTALLINE DIAMOND CUTTING ELEMENT AND BIT BODY ASSEMBLIES

(71) Applicant: Smith International, Inc., Houston, TX (US)

(72) Inventors: Anthony Griffo, The Woodlands, TX (US); Alysia C. White, Richmond, TX (US); Sameer R. Kachhia, Houston, TX (US); Youhe Zhang, Spring, TX (US)

(21) Appl. No.: 14/729,618

(22) Filed: Jun. 3, 2015

Related U.S. Application Data
(60) Provisional application No. 62/008,315, filed on Jun. 5, 2014.

(51) Int. Cl. E21B 10/55; B23K 1/00; E21B 10/42

(52) U.S. Cl. CPC E21B 10/55; E21B 10/42; B23K 1/0008

(57) ABSTRACT

A tool including a body defining a pocket, a cutting element in the pocket, at least one projection between an outside surface of the cutting element and an inside surface of the pocket, and a braze material between the cutting element and the pocket fixing the cutting element to the pocket.

### CROSS-REFERENCE TO RELATED APPLICATION

This application claims priority to and the benefit of U.S. Provisional Patent Application No. 62/008,315, filed on Jun. 5, 2014, the entire disclosure of which is incorporated herein by reference.

### BACKGROUND

Various types and shapes of earth boring bits are used in various applications in the earth drilling industry. Earth boring bits have bit bodies which include various features such as a core, blades, and pockets that extend into the bit body or roller cones mounted on a bit body, for example. Depending on the application/formation to be drilled, the appropriate type of drill bit may be selected based on the cutting action type for the bit and its appropriateness for use in the particular formation. For example, in polycrystalline diamond compact (PDC) bits, polycrystalline diamond (PCD) compact cutters are received within pockets in the bit body and are typically bonded within the pocket by brazing to the inner surfaces of the pockets. Bit bodies are typically made either from steel or from a tungsten carbide matrix bonded to a separately formed reinforcing core made of steel.

Matrix bit bodies are typically formed of a single, relatively homogenous composition throughout the bit body. The single composition may constitute either a single matrix material such as tungsten carbide or a mixture of matrix materials such as different forms of tungsten carbide. The matrix material or mixture thereof, is commonly bonded into solid form by fusing a metallic binder material and the matrix material or mixture.

The drill bit formation process typically includes placing a matrix powder in a mold. The mold is commonly formed of graphite and may be machined into various suitable shapes. Displacements are typically added to the mold to define the pockets. The matrix powder may be a powder of a single matrix material such as tungsten carbide, or it may be a mixture of more than one matrix material such as different forms of tungsten carbide. The matrix powder may include further components such as metal additives. Metallic binder material is then typically placed over the matrix powder. The components within the mold are then heated in a furnace to the flow or infiltration temperature of the binder material at which the melted binder material infiltrates the tungsten carbide or other matrix material. The infiltration process that occurs during sintering (heating) bonds the grains of matrix material to each other and to the other components to form a solid bit body that is relatively homogenous throughout. The sintering process also causes the matrix material to bond to other structures that it contacts, such as a metallic blank which may be suspended within the mold to produce the aforementioned reinforcing member. After formation of the bit body, a protruding section of the metallic blank may be welded to a second component called an upper section. The upper section typically has a tapered portion that is threaded onto a drilling string.

The bit body typically includes blades which support the PCD cutters which, in turn, perform the cutting operation. The PCD cutters are bonded to the body in pockets in the blades, which are cavities formed in the bit for receiving the cutting elements. In such bits, the PCD cutters are disposed in a respective pocket and a braze material is interposed between the PCD cutter outside surface and the pocket inside surface, and is used to bond and fix the PCD cutter within the bit. In such bits there exists a tolerance between the PCD cutter outside surface and the pocket inside surface that provides a gap for the braze material.

### SUMMARY

A tool as disclosed herein includes a body defining a pocket, a cutting element in the pocket, at least one projection between an outside surface of the cutting element and an inside surface of the pocket, and a braze material between the cutting element and the pocket, fixing the cutting element to the pocket. The tool may be a bit, such as a matrix body bit or a steel body bit. The cutting element may be an ultra-hard material body attached to a metallic substrate.

In some embodiments, the projections may be positioned along the pocket wall surface and/or along the pocket base surface, and may extend from one or both of the cutting element and the pocket. The projections may be provided in the form of continuous, segmented, or point surface features, and may be oriented having a constant or changing location, e.g., extending in a helical fashion within the pocket.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features and advantages of the present disclosure will be appreciated as the same becomes better understood by reference to the following detailed description when considered in connection with the accompanying drawings wherein:

FIG. 1 illustrates a cutting element according to embodiments of the present disclosure;

FIGS. 2A and 2B illustrate schematic cross-sectional views of a cutting element and bit pocket assembly;

FIG. 3 illustrates a schematic cross-sectional view of a cutting element and bit pocket assembly according to embodiments of the present disclosure;

FIGS. 4A, 4B, 4C, and 4D illustrate perspective side cut away views of bit pockets according to embodiments of the present disclosure;

FIG. 5 illustrates a cutting element for use with a cutting element and bit pocket assembly according to embodiments of the present disclosure; and

FIG. 6 illustrates a perspective view of a drill bit including the cutting element and bit pocket assembly according to embodiments of the present disclosure.

### DESCRIPTION

According to embodiments of the present disclosure, bit pockets as disclosed herein provide a defined and constant (e.g., a substantially constant) braze gap tolerance to encourage or promote a uniform braze strength of cutting elements within respective pockets. In an example, a pocket includes one or more surface features, such as ridges or projections, extending outwardly away a defined distance from an inside wall surface of the pocket to make contact with an adjacent cutting element outside surface. Such surface features may center the cutting element therein and define a uniform braze gap therebetween. The projections may be configured as needed to enable the braze material to flow and fill in the gap to allow the desired attachment strength with the cutting element to be achieved.

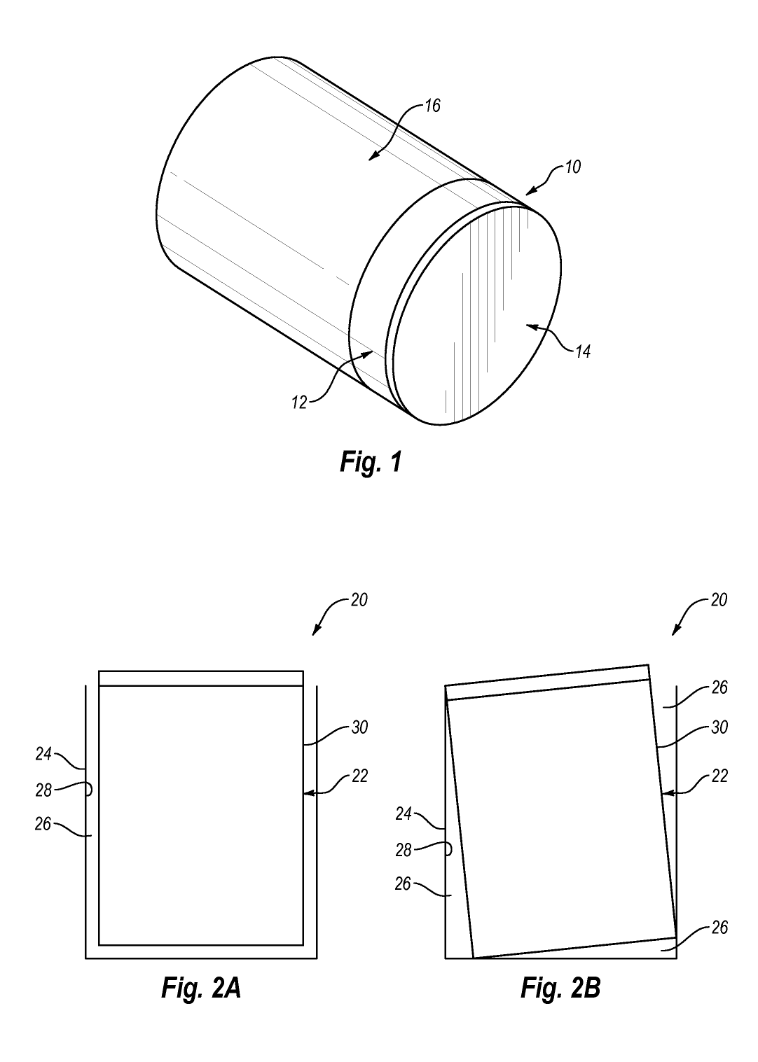

In some embodiments, cutting elements as disclosed herein are polycrystalline diamond (PCD) cutting elements, however, any suitable cutting element may be used. For example, an ultra-hard cutting element, such as polycrystalline cubic boron nitride (PCBN), may also be used. FIG. 1 illustrates an example cutting element 10 including a ultra-hard material body 12 (e.g., a PCD body) having an upper wear surface 14 of the cutting element. The PCD cutting element 10 may include a thermally stable region, e.g., a region that either has had the catalyst material removed by leaching or other process or that includes a catalyst material that has been otherwise selected or treated so as to render the intercrystalline diamond matrix thermally stable, e.g., not subject to graphitization under conditions of high temperature when placed into an end-use application. The ultra-hard material body 12 is attached to a substrate 16, e.g., a metallic substrate, such as WC-Co, another carbide material, or the like.

While particular cutting elements and bit pocket assemblies have been described and illustrated herein, it is to be understood that other cutting elements and/or bit pockets configured differently than that disclosed may be within the scope of the concept as disclosed herein. For example, cutting elements as disclosed herein may include those having a rounded rather than a flat wear surface. Cutting elements may also include wear surfaces having a pointed tip or the like, e.g., conical cutting elements. Cutting elements may also include wear surfaces having other symmetric or non-symmetric surfaces. Thus, cutting elements as disclosed herein are understood to include any and all configurations of cutting elements that may be used with tools, such as downhole tools or bits for drilling subterranean formations.

FIGS. 2A and 2B illustrate cutting element and bit pocket assemblies 20 including a cutting element 22 that is disposed within a drill bit pocket 24, and wherein the pocket has a particular tolerance 26 or gap between a pocket inside surface 28 and the cutter outside surface 30 to accommodate the cutting element within the pocket and to provide a gap for braze material to attach the cutter within the pocket. Such conventional bit pockets may be formed in matrix body bits by a manual grinding process or by machining a sand/phenolic displacement used in making the matrix bit body as described above. Such methods may have manufacturing variation and/or tolerance issues that result in producing an unfavorable variation, thereby providing a gap that is not uniform within the pocket.

FIG. 2B illustrates how, during installation of the cutting element 22, the cutting element may become canted or un-centered within the axis of the pocket 24 so as to produce a gap 26 between the cutting element and pocket having a large amount or degree of variation. Such variation in the gap may result in the braze material having a reduced attachment strength, e.g., in areas where the gap is relative small or even nonexistent, and having an increased braze amount, e.g., in areas where the gap is relatively large. Such variation in the gap and the resulting variation in the volume of the braze material therein provide an attachment between the cutting element 22 and the bit pocket 24 having a reduced strength that may subject the cutting element to premature failure once placed into an end-use application. Further, with each repair to the bit, e.g., by removing a damaged cutter from a pocket and then replacing the damaged cutter with a new cutter, more variation in the gap may be introduced that may tend to further exasperate the variation in gap and the resulting relative weakness of the braze attachment between the cutter and the pocket resulting therefrom.

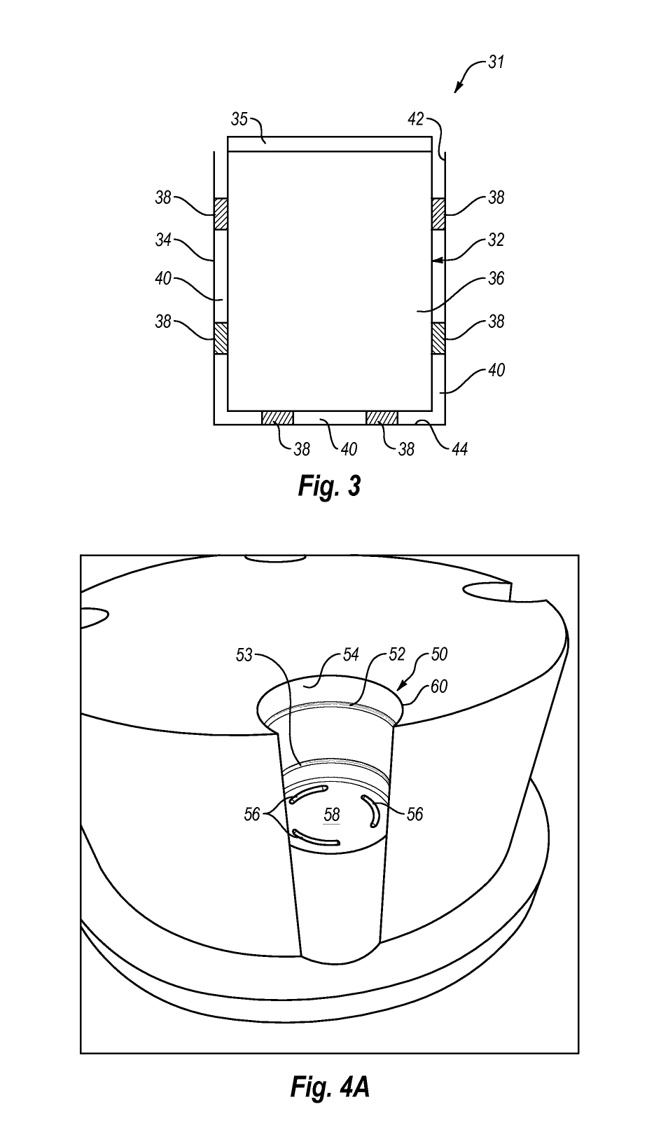

FIG. 3 illustrates a cutting element and bit pocket assembly 31 as disclosed herein including a cutting element 32 that is disposed within a pocket 34. In some embodiments, the cutting element is a PCD cutter, including a diamond-bonded body 35 disposed on the top of the cutter and attached to an underlying substrate 36 (e.g., a metallic substrate). As shown in FIG. 3, the bit pocket assembly 31 includes one or more ridges or projections 38 interposed between adjacent surfaces of the cutting element and the bit pocket to define a uniform gap 40 therebetween, centering the cutting element within the pocket (e.g., for promoting a uniform braze thickness and a desired attachment strength between the cutting element and pocket). In some embodiments, the ridges or projections 38 may extend outwardly from an outside surface of the cutting element (e.g., from an outside surface of the substrate of the cutting element 32) and/or outwardly from an inside surface of the pocket 34. In some embodiments, the projections extend from an inside surface of the pocket 34 and one or more of the projections are in direct contact with the substrate portion of the cutting element.

In some embodiments, the projections 38 are positioned along both a sidewall surface 42 of the pocket and/or along a base or bottom surface 44 of the pocket, thereby defining a braze gap 40 (e.g., a uniform braze gap) along both regions to center the cutting element within the pocket. Configured in this manner, a uniform braze thickness (e.g., a substantially uniform braze thickness) will exist between the cutting element and the bit pocket to ensure or promote a desired level of attachment strength therebetween (e.g., a high level of attachment strength) according to some embodiments of the present disclosure. In some embodiments, the projections allow braze material to flow more freely within the gap (e.g., to flow more freely than in conventional pockets) so that regions in the gap that do not include the braze material, e.g., porous regions, are minimized or reduced. Such porous regions in conventional pockets may compromise the desired braze attachment strength. In some embodiments, the projections 38 may only be positioned along the sidewall surface 42, while in some embodiments, the projections may only be positioned along the base or bottom surface 44.

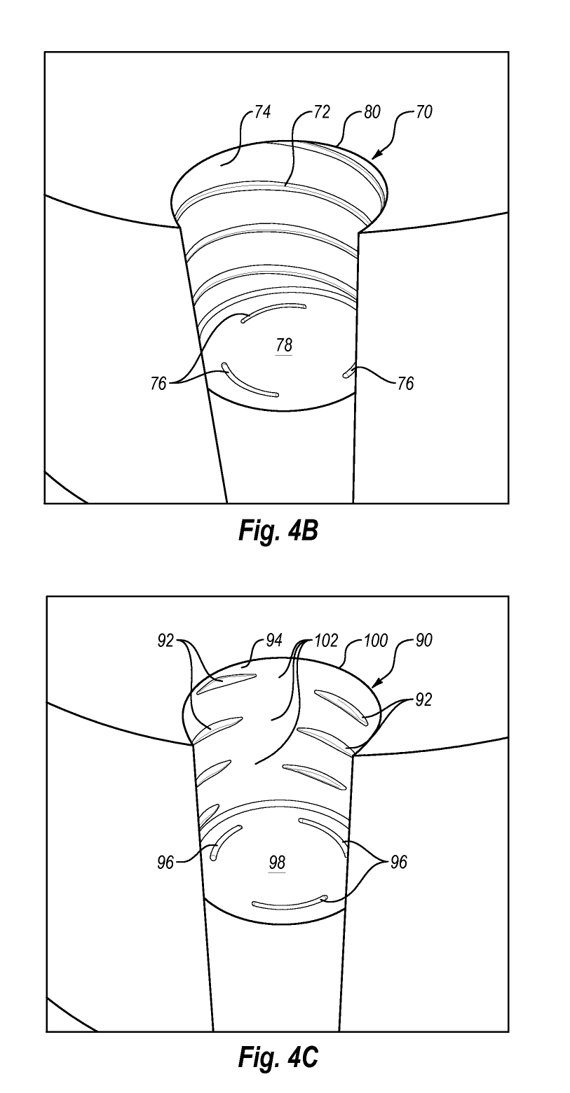

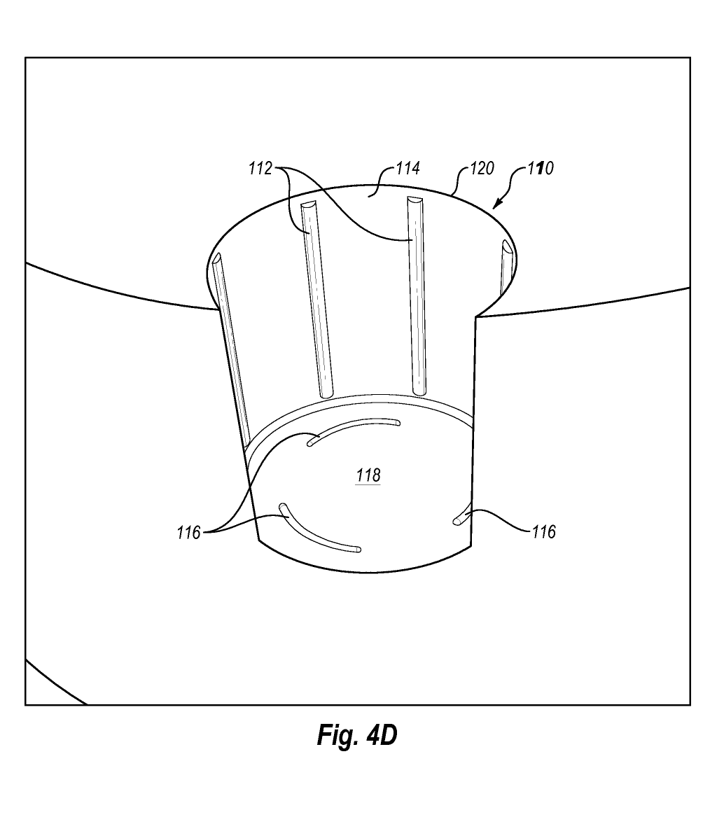

FIG. 4A illustrates an example pocket 50 including a number of projections 52 and 53 extending outwardly a distance from a sidewall surface 54 of the pocket, and including a number of projections 56 extending upwardly a distance from a base surface 58 of the pocket. The placement position of the projections along both the sidewall and base may vary depending on the desired parameters (e.g., a particular end-use application), as may the shape, size, or distance that the projections extend therefrom. In some embodiments, the projections may extend a distance that is sufficient to permit the flow of braze material within the gap to the pocket and in some embodiments, the projections may extend a distance that is sufficient to provide a desired or set degree of attachment strength with the braze. In some embodiments, the projections are located and configured to contact the cutting element and position it centrally relative to the pocket. In some embodiments, the surface area of the projections in contact with the cutting element is minimized or reduced so that the desired attachment strength provided by the braze material is not significantly or greatly affected.

In an example, the extension distance of the projection is based on the desired or target braze gap, e.g., for a particular end-use application. In some embodiments, the projection may extend a distance (e.g., a height from the sidewall or base) of greater than about 0.02 mm, or in the range of from about 0.05 to 0.3 mm, or in the range of from about 0.5 to 0.15 mm. The height of each projection may be constant, or it may vary, and each projection may have a height that is different or the same from other projections. In some embodiments, the projection has a width that is the same as or similar to its extension distance (e.g., a width of greater than about 0.02 mm, or in the range of from about 0.05 to 0.3 mm, or in the range of from about 0.5 to 0.15 mm), and the width may be constant or may vary, and each projection may have a width that is different or the same from other projections. In some embodiments the projections are configured to extend at or near the desired braze gap, causing a tight clearance to enable the cutter to be placed within the pocket. In some embodiments, the projections limit movement of cutting element in the pocket that is otherwise the result of tolerance issues or gravity. In some embodiments, the top of the projections (e.g., line segments) may be angular (e.g., pointed or square), rounded, or the like. As will be discussed below, the projections may be replaceable, and in such case, the height of the projection(s) may be changed by replacing them with projections having a different height.

In the example illustrated in FIG. 4A, the pocket 50 includes a pair of projections 52 and 53 disposed along the pocket sidewall surface 54, where one projection 52 is positioned a distance below a pocket opening 60 and the other projection 53 is positioned a distance above the pocket base surface 58. In some embodiments, the first and second projections 52 and 53 are positioned to stabilize the cutting element therein. In the embodiment shown in FIG. 4A, the projections extend circumferentially within the pocket in a parallel orientation with respect to one another. For example, the first or upper projection 52 may be at or adjacent a point that is at about ⅓^{rd} of the cutter length, and the second or lower projection 53 may be at or adjacent a point that is at about ⅔^{rd} of the cutter length to stabilize the cutting element within the pocket. In an example, the projection 52 located adjacent the pocket opening 60 be positioned at a location along the pocket sidewall surface that is at least about 2 mm from, or in the range of from about 3 to 6 mm from, the ultra-hard material table (e.g., diamond table) of the cutting element when the cutting element is disposed within the pocket or at least about 0.6 mm from the top of the pocket sidewall surface. A first or uppermost sidewall projection 52 that is positioned too close to the diamond table of the cutting element may interact with diamond table, which may be unfavorable during operation, and may not provide a stabilizing effect on the cutting element. Additionally, the braze material may not bond to the diamond table thereby allowing undesirable porosity in the braze gap, which could lead to a reduced attachment strength. A first or uppermost sidewall projection 52 that is positioned too far away from the diamond table of the cutting element may not provide sufficient position control to prevent unwanted canting, or off-center positioning, of the cutter in a pocket due to dimensional issues or cutter position (e.g., due to gravity).

In some embodiments, the projection 53 located adjacent the pocket base surface 58 is along the pocket sidewall surface at least about 0.2 mm from, or in the range of from about 0.4 to 1 mm, or, in one embodiment, about 0.6 mm from the pocket base surface 58. A second or lowermost sidewall projection 53 that is too close to the pocket base surface may prevent flux, used to clean the braze joint, from freely flowing out of the pocket, which may create an unfavorable braze gap or porosity. Additionally, in some embodiments, the cutting element has a bevel or chamfer near the bottom, and the projection 53 may be far enough away from the pocket base surface 58 above the bevel or chamfer so as to be clear from the bevel or chamfer. A second or lowermost sidewall projection 53 that is too far away from the pocket base surface may be too close to the upper projection 52 so as to inhibit or reduce braze flow, creating braze gap having a reduced braze strength. Also, if the lower projection 53 is too close to the upper projection 52, the projections together may not operate effectively to constrain or stabilize the cutter element within the pocket to provide a desired centered placement that resists being canted.

To ensure complete migration or to encourage migration of the braze material within the braze gap downwardly from the pocket opening 60 to the base 58 once the cutting element is installed, the projections 52 and 53 extending from the pocket sidewall surface 54 may be in two or more segments that are disconnected from one another by a section of the sidewall surface, so that the braze material can freely pass downwardly into the pocket between the space that exists along the sidewall section between the disconnected segments. An example illustrating projections provided in the form of segments is illustrated in FIG. 4C and is described in more detail below. Similarly, the projections 56 projecting upwardly from the pocket base surface 58 may also be provided in the form of segments (as illustrated in FIG. 4A), e.g., in two or more disconnected segments, that in some embodiments promote the free flow of braze material within the braze gap existing between the adjacent cutter and pocket base surfaces to promote a strong attachment therebetween. In some embodiments, the projection segments along the pocket sidewall surface may be separated from one another by a distance of at least 0.2 mm, or in the range of from about 0.2 to 5 mm. The projection segments along the pocket base surface may be separated by the same amount as the sidewall projection segments.

While projections along the sidewall surface and base surface of the pocket have been illustrated and described in the form of a ridge or a series of segments, it is to be understood within the scope of the concept as disclosed herein that such projections may also be provided in the form of a single or plurality of points, i.e., not having an elongated configuration in the form of a line or line segments. For example, the projections could also be one or more point surface features (e.g., one or more rounded projections, e.g., semi-spherical projections or semi-ellipsoid projections; conical or pyramidal projections; conical frustum or pyramidal frustum projections; or prismatic projections) or the like. Such projections may have the same size as the projections described above, e.g., a distance from the pocket sidewall or base (e.g., a height from the sidewall or base) of greater than about 0.02 mm, or in the range of from about 0.05 to 0.3 mm, or in the range of from about 0.5 to 0.15 mm and a width of greater than about 0.02 mm, or in the range of from about 0.05 to 0.3 mm, or in the range of from about 0.5 to 0.15 mm. A combination of continuous lines, segmented lines, and/or one or more point surface features (which could be the same or different shapes) may be used in any shape or configuration. For example, a plurality of point surface features (which could be the same or different shapes) may be arranged in a repeating pattern of projections, such as a grid pattern, or an irregular arrangement of projections.

While the example assembly in FIG. 4A illustrates a pair of sidewall projections 52 and 53, and three projection segments 56 along the base surface 58, bit pockets as disclosed herein may have a number of sidewall projections and/or base projections positioned and/or configured differently from this while being within the scope of the concepts disclosed herein. For example, while in some embodiments it is desired that the cutting element be in contact with opposed projections along the sidewall surface, and at least one projection extending from the base surface, the exact number of sidewall and base surface projections may vary depending on the particular end-use application.

FIG. 4B illustrates an example bit pocket 70 including a projection 72 extending outwardly a distance from a sidewall surface 74 of the pocket, and a number of projections 76 extending upwardly a distance from a base surface 78 of the pocket. In this example, the projection 72 extending from the sidewall surface is one starting adjacent the pocket opening 80 and running in a helical fashion (or helical pattern) downwardly towards the base surface 78. The projection 72 extends a distance and has a width that could be within the distance and width as described above.

The helical pattern has a pitch or helix angle relative to a horizontal axis running between diametrically opposed pocket sidewall surfaces. In an example, the helix angle may be greater than about 5 degrees, from about 5 to 80, or from about 10 to 45 degrees with respect to the plane at the base of the pocket base surface 78. The helix angle is provided to both promote a desired flow of the braze material downwardly within the braze gap and to promote a uniform braze gap between the cutting element outside surface and the pocket inside wall surface to center and stabilize the cutting element within the pocket. A helix projection having too small of an angle (e.g., a shallow an angle of departure) may not operate to facilitate the flow of braze material downwardly to the braze gap (e.g., to all regions of the braze gap), while a helix projection having too great of an angle (e.g., to great of an angle of departure) may not provide the desired uniform braze gap along the pocket sidewall surface and/or may not operate to provide a desired degree of stability to the cutter element.

In the example illustrated in FIG. 4B, the projection 72 may start at the pocket opening 80 or a desired distance below the pocket opening (e.g., at about ⅓^{rd} of the cutter length or at least about 2 mm from or in the range of from about 3 to 6 mm from the ultra-hard material table or about 0.6 mm or greater from the top of the pocket opening). The projection 72 may extend all the way down to the pocket base surface 78 or may stop a distance before reaching the pocket base surface (e.g., at about ⅔^{rd} of the cutter length or at least about 0.2 mm from or in the range of from about 0.4 to 1 mm, or, in one embodiment, about 0.6 mm from the pocket base surface 78). In this example, the projection 72 is a continuous helical surface feature rather than in the form of a segmented series of detached projections. Also, the projections 76 extending from the pocket base surface 78 are arranged in the form of a series of detached segments that have a circular pattern, as with the pocket base projections in the example of FIG. 4A. In this example, the projections 76 are provided in the form of three detached projection segments each having a common radius of curvature. In some embodiments, the radius of curvature for such segments is less than about 95 percent or in the range of from about 85 to 25 percent of the radius of curvature defining the cylindrical pocket sidewall surface.

The spaces between the projection segments along the base surface operate to facilitate the flow of braze material to fill in the braze gap region existing between a bottom portion of the cutting element and the base surface of the pocket. While a particular configuration of projections along the pocket base surface has been described and illustrated, e.g., in the form of segments having a common radius of curvature, it is to be understood that different configured projections may be used to achieve the same purpose, i.e., provide a uniform braze gap and facilitate the flow of braze material within the braze gap, and such other configurations are within the scope of the concept as described herein. For example, instead of being provided in the form elongated segment, the projections can be provided in the form of one or more single projections in the form of circular bumps, points, and the like.

FIG. 4C illustrates an example bit pocket 90 as disclosed herein comprising a number of projections 92 configured in the form of a series of detached segments extending outwardly a distance from a sidewall surface 94 of the pocket, and comprising a number of projections 96 extending upwardly a distance from a base surface 98 of the pocket. In this particular example, the projections 92 extending from the sidewall surface are provided in the form of a series of detached elongated segments that extend along the pocket sidewall surface in a helical pattern starting adjacent the pocket opening 100 and running in a helical fashion downwardly towards the base surface 98. The projections extend a distance and have a width that is the same as that described above, and the helical pattern has a pitch or helix angle relative to a horizontal axis running between diametrically opposed pocket sidewall surfaces as described above for the example illustrated in FIG. 4B.

A feature of the bit pocket configuration of FIG. 4C is that the use of the helically-oriented detached projection segments operates to facilitate the flow of braze material downwardly within the braze gap both by migrating along the helical projections and by migrating downwardly along the open sections 102 of the pocket sidewall surface not including the projection segments. In an example, the projection segments may have a length that is the same, greater than, or less than that of the open sidewall surfaces separating the same. In an example, the segments are configured so that they are diametrically opposed to one another to provide a desired degree of cutter element stability, as are the open sections of the pocket sidewall surface.

As illustrated in FIG. 4C, the relative positioning of the projection segments along the pocket sidewall, moving downwardly from the opening to the base surface, may be slightly offset from one another. This vertical staggering of the projection segment locations operates to further facilitate braze material flow through the pocket to the braze gap (e.g., to all regions of the braze gap). While this is but one example of how projection segments may be positioned within the pocket, it is to be understood that projection segments as used with bit pockets may be positioned differently and that such is intended to be within the scope of the concept as disclosed herein.

FIG. 4D illustrates an example pocket 110 including a number of projections 112 extending outwardly a distance from a sidewall surface 114 of the pocket, and including a number of projections 116 extending upwardly a distance from a base surface 118 of the pocket. The placement position of the projections along both the sidewall and base may vary depending on the desired parameters (e.g., a particular end-use application), as may the shape, size, or distance that the projections extend therefrom, as described in embodiments above. As shown in FIG. 4D, the projections may extend axially along the length of the pocket. For example, the projections 112 may start at the pocket opening 120 or a desired distance below the pocket opening (e.g., at about ⅓^{rd} of the cutter length or at least about 2 mm from or in the range of from about 3 to 6 mm from the ultra-hard material table or about 0.6 mm or greater from the top of the pocket opening). The projection 72 may extend all the way down to the pocket base surface 118 or may stop a distance before reaching the pocket base surface (e.g., at about ⅔^{rd} of the cutter length or at least about 0.2 mm from or in the range of from about 0.4 to 1 mm, or, in one embodiment, about 0.6 mm from the pocket base surface 78).

In some embodiments, multiple axial projections may be included in each cutter pocket, and the axial projections may be circumferentially spaced apart from one another. For example, as shown in FIG. 4D, four axial projections may be included. However, in other embodiments, any suitable number of axial projections may be included, e.g., from 3 to 5 axial protrusions. The axial projections may be evenly spaced apart or the protrusions may be irregularly spaced apart. One or more of the axial projections may be spaced apart by limits of 10°, 20°, 30°, 40°, 50°, 60°, or 80°, where any limit may be used in combination with any other limit (e.g., 10° to 80° or 30° to 60°). As with the embodiments described above, solid projections may be included, or the projections may be split into two or more segments that are disconnected from one another by a section of the sidewall surface may be used, which may aid in braze flow as described above. In addition, combinations of axial and circumferential projections may be used. For example, an axial projection may extend from the base surface 118 up a portion of the sidewall surface 114. The axial projection may then transition to a circumferential projection that extends a portion along the circumference of the sidewall surface 114. The circumferential projection may then transition to another axial projection that extends to the top of the cutter pocket, forming a Z shape.

One or more of the projections may be angled to promote or encourage braze flow. For example, in the embodiment shown in FIG. 4D each of the axial projections may be in the shape of the helix, where the helix angle is greater than about 5 degrees, from about 5 to 45, or from about 15 to 30 degrees with respect to the axis of the cutter pocket. The helix angle may be continuous or it may vary throughout the length of the projections. In addition, a combination of mostly axial and mostly circumferential projections (e.g., the Z shape as described above), may also each include a helix angle or may variably curve throughout their segment lengths. For example, the axial segment from the base surface 118 to the circumferential segment may have a helix angle of from about greater than 0 to 30° with respect to the axis of the cutter pocket, the circumferential segment may have a helix angle of about greater than 0 to 30° with respect to the plane at the base surface 118, and the axial segment from the circumferential segment to the top of the cutter pocket may have a helix angle of from about greater than 0 to 30° with respect to the axis of the cutter pocket. While described as a continuous projection, the segments may be connected or discontinuous, and each segment may also be connected or discontinuous, as described above. Furthermore, the segments may all have a helix angle, or one or more of the segments may have a helix angle. The helix angle of each segment may be continuous or variable.

While cutting element and pocket assemblies as disclosed and illustrated above have featured the use of projections extending from sidewall and base surfaces of the pocket (e.g., for the purpose of providing a desired centered alignment of the cutting element, for providing cutting element stability within the pocket, or for providing a uniform braze gap therebetween to ensure or promote a desired attachment strength), it is to be understood that the same objective may be achieved from an assembly configured with projections extending from the cutting element rather than the pocket, or from an assembly whereby the projections extend from both the cutting element and the pocket using any of the disclosed configurations.

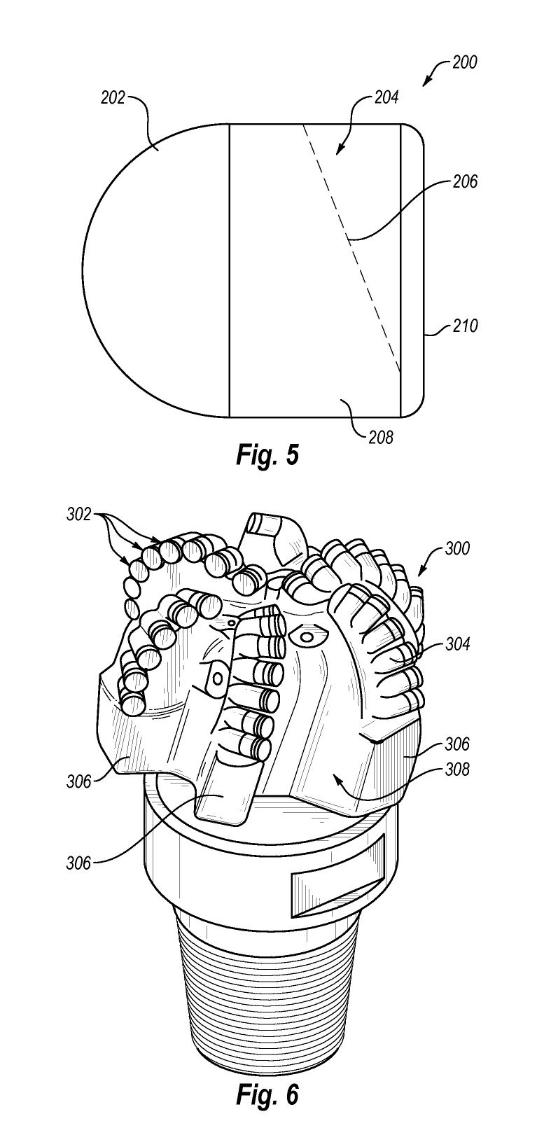

FIG. 5 illustrates a cutting element 200, for use with a cutting element and bit pocket assembly as disclosed herein, including a diamond-bonded body or wear layer 202 that is attached to an underlying metallic substrate 204. In this example, the body 202 is configured having a dome-shaped top surface, but it is understood that the cutting element may be configured having any other type of symmetrical or non-symmetrical three-dimensional top surface or a flat top surface, as with the cutting element illustrated in FIG. 1. The cutting element 200 has one or more projections 206 extending outwardly a distance from a sidewall surface 208. The projections 206 may extend a distance and have a width as disclosed above for the pocket, and may start and end relative to the respective diamond table and base of the cutting element also as disclosed above for the pocket. For example, the projections may start at about ⅓^{rd} of the cutter length, or at least about 2 mm from or in the range of from about 3 to 6 mm from the ultra-hard material and the projections may end at about ⅔^{rd} of the cutter length or at least about 0.2 mm from or in the range of from about 0.4 to 1 mm, or, in one embodiment, about 0.6 mm from the base of the cutter. In some embodiments, the projections may extend the length of the carbide.

In this example, the cutting element includes projections 206 that extend along the length of the cutting element sidewall surface in a helical fashion as described above for the pocket. In an example, the cutting element may include more than one helical projection, e.g., a first helical projection starting adjacent the diamond-bonded body, and a second helical projection offset a distance away from the first helical projection and running parallel with the first helical projection along a length of the outside surface. In such example, the helical projections may be positioned or offset apart from one another a distance of between about 1.5 to 5 mm, depending on the particular size of the cutting element and/or the end-use application. Further, the projections may be provided in the form of a continuous surface element, in the form disconnected segments, or in the form of point elements as discussed above for the pocket. In addition, projections having other shapes (e.g., horizontal projections as shown in FIG. 4A and described above, vertical projections as shown in FIG. 4D and described above) may also be used. In addition, while using multiple helical projections was described for use on a cutting element, such a configuration could also be used for projections on the cutter pocket.

While a cutting element has been disclosed and illustrated having a particular projection configuration, it is to be understood that cutting elements as disclosed herein may be configured having projections that are configured differently than as illustrated that operate in the same manner as projections in the bit pocket, e.g., to align the cutting element within the pocket, to stabilize and center the cutting element in the pocket, or to provide a desired uniform braze gap to ensure a desired braze attachment strength. Also, while the cutting element illustrated in FIG. 5 does not show projections along a base surface 210, cutting elements as disclosed herein may include such projections. In the example illustrated, the bit pocket could include one or more projections along the base surface to provide the desired braze gap between the adjacent base surfaces of the cutting element and the bit pocket.

Cutting element and pocket assemblies according to embodiments of the present disclosure include pockets and/or cutting elements including one or more projections extending along sidewall and base surfaces, for example, for the purpose of aligning the cutting element within the bit pocket, for stabilizing the cutting element within the pocket, or for providing a uniform braze gap therebetween that results in providing a desired braze attachment strength that operates to maximize or increase the service life of the cutting element and bit including the same.

The bit pockets as disclosed herein may be ones that are formed in matrix body drill bits, and may have a cylindrical sidewall of uniform diameter (e.g. substantially uniform diameter) extending from a pocket opening to a base surface. The projections as disclosed herein may be formed in such matrix body drill bits by casting methods that include split casting, injection molding, or the like. Matrix bodies may be made in any suitable manner, for example, by filling a mold (e.g., a graphite mold) with a matrix powder (e.g., tungsten carbide), loading an binder on the top of the matrix powder, and heating the assembly to allow the binder to infiltrate into the matrix powder. The pockets may be formed from a silica/phenolic resin molding that is formed into a desired shape and placed in the mold, and the pockets are subsequently turned by lathe to a desired final shape. In some embodiments, the resin molding may be machined to form grooves corresponding to the projections so that when matrix powder is placed in the mold, the matrix material fills the grooves to form the projections after infiltration. In some embodiments, rather than allowing the matrix material to fill the grooves, a hard material, (such as steel, presintered tungsten carbide, other refractory metals, thermally stable polycrystalline diamond, or the like) e.g., an ultra-hard material, is placed and/or fixed in the grooves prior to placing the resin molding in the mold. When such a mold with resin molding and hard material segments is infiltrated during the manufacture of the matrix body bits, the hard material segments are fixed to the cutter pockets. In some embodiments, the projections may be formed by machining the pockets after the pockets are formed. In some embodiments, the resin molding may be formed via additive manufacturing to have the grooves. The hard material pieces may be infiltrated in, brazed in, adhered in using other adhesives, or fixed by any other suitable method. Some methods of fixing the hard material pieces, e.g., the use of adhesives, allow the projections to be replaceable, allowing the replacement of projections with the same or a different type of projection upon wear and/or damage. In some embodiments, where a drill bit is manufactured using additive manufacturing, the projections may be directly printed onto the pocket.

Bit pockets as disclosed herein may also be ones that are formed in steel drill bit bodies or steel surface features extending from drill bit bodies, e.g., steel blades extending from drill bit bodies. Examples include bit bodies or blades formed from steel grades such as 4130 and 4140. The bit pockets as disclosed herein formed in such steel material have a cylindrical sidewall of uniform diameter (e.g., substantially uniform diameter) extending from a pocket opening to a base surface. The projections as disclosed herein may be formed in such bit bodies or bit surface features by a single or multi-machining process, e.g., wherein a first machining process is used to form an undersized bore that reflects the dimension of the projections, and a second machining process is used to form the pocket bore and leave the undersized bore that form the projections. The machining process for forming pockets in steel bits or bit surface features as disclosed herein may be of a continuous or a segmented-type operation. In some embodiments, the pockets may be machined, and rather than machining the projections so that they are an integral part of the steel body, the pockets may be machined to provide regions where carbide, TSP, or other hard material may be fixed to the cutter pockets as projections (e.g., brazed to the pocket using a higher temperature adhesive or braze than the temperature used to fix the cutters to the cutter pockets).

FIG. 6 illustrates a matrix body drill bit 300 including a plurality of the cutting elements 302 disposed in pockets 304 as described above. The cutting elements in this example are PCD cutters (as illustrated in FIG. 1) and are disposed within the pockets 304 that are positioned within blades 306 that extend from a head 308 of the bit for cutting against a subterranean formation being drilled.

While embodiments of the present disclosure have been described in reference to a drill bit, the cutter pockets may also be used in other tools using cutters. For example, embodiments of the present disclosure may be used with mills, reamers, other downhole tools, or any other tools that receive a cutting element into a pocket.

Although just a few embodiments have been described in detail above, those skilled in the art will appreciate that many modifications are possible in the example embodiments without materially departing from the apparatus, systems, and methods disclosed herein. Accordingly, such modifications are intended to be included within the scope of this disclosure. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke means-plus-function for any limitations of any of the claims herein, except for those in which the claim expressly uses the words ‘means for’ together with an associated function. Each addition, deletion, and modification to the embodiments that fall within the meaning and scope of the claims is to be embraced by the claims.

What is claimed is:

1. A bit for drilling subterranean formations comprising:
a body defining a number of pockets, each pocket having a sidewall surface and a base surface;
a number of cutting elements in respective pockets, each cutting element comprising a ultra-hard body attached to a metallic substrate;
one or more projections between an outside surface of each cutting element and the sidewall surface of each pocket; and
a braze material between and attaching each cutting element to each pocket.

2. The drill bit as recited in claim 1, wherein the sidewall is a cylindrical sidewall with constant diameter that extends from a pocket opening to a base surface.

3. The drill bit as recited in claim 1, wherein the one or more projections comprise one or more projections extending outwardly a distance from the pocket sidewall surface and one or more projections extending outwardly a distance from a pocket base surface.

4. The drill bit as recited in claim 1, wherein the sidewall surface comprises at least two projections extending therefrom that are positioned apart from one another, wherein one projection is positioned adjacent an opening of the pocket and another projection is positioned adjacent the pocket base surface.

5. The drill bit as recited in claim 1, wherein the one or more projections comprise one or more projections extending outwardly a distance from the pocket sidewall surface and the one or more projections is continuous.

6. The drill bit as recited in claim 1, wherein the one or more projections comprise a projection extending outwardly a distance from the pocket sidewall surface, from a position adjacent an opening of the pocket to a position adjacent the pocket base surface, in a helical pattern.

7. The drill bit as recited in claim 1, wherein the one or more projections comprise a projection extending from the pocket sidewall surface and having discrete disconnected segments.

8. The drill bit as recited in claim 7, wherein the projection extends from a position adjacent an opening of the pocket to a position adjacent the pocket base surface in a helical pattern.

9. The drill bit as recited in claim 1, wherein the one or more projections extend outwardly from a surface of the cutting element.

10. A downhole tool comprising:
a body defining a number of pockets;
a number of cutting elements in respective pockets, each cutting element comprising a polycrystalline body attached to a metallic substrate;
one or more projections extending outwardly from a wall surface of each pocket to contact and align each cutting element within each pocket, the one or more projections being positioned within each pocket to provide a gap that is uniform in dimension between each cutting element and each pocket; and
a braze material within the gap to attach the cutting elements to the pockets.

11. The downhole tool as recited in claim 10, wherein the pocket has a cylindrical wall with constant diameter.

12. The downhole tool as recited in claim 10, further comprising one or more projections extending upwardly from a base surface of the pocket.

13. The downhole tool as recited in claim 10, wherein the one or more projections extend along at least a region of the pocket adjacent a pocket opening and along a region of the pocket adjacent a pocket base surface.

14. The downhole tool as recited in claim 10, wherein at least one of the projections extends continuously along the pocket wall surface.

15. The downhole tool as recited in claim 14, wherein the at least one projection extends in a helical fashion along the pocket wall surface.

16. The downhole tool as recited in claim 10, wherein at least one of the projections extends in the form of disconnected segments along the pocket wall surface.

17. The downhole tool as recited in claim 16, wherein the segments extend in a helical fashion along the pocket wall surface.

18. The downhole tool as recited in claim 10, where at least one of the projections extends axially along the pocket wall surface.

19. A method for aligning a cutting element within a tool pocket comprising:
inserting a cutting element into a pocket disposed within the tool, the pocket having a cylindrical wall surface of constant diameter that extends from a pocket opening to a pocket base surface;
forming a uniform gap between the cutting element and the pocket through the use of one or more projections interposed between adjacent surfaces of the cutting element and the pocket; and
introducing a braze material between the cutting element and the pocket and allowing the braze material to migrate into the gap to fix the cutting element and the pocket.

20. The method as recited in claim 19, wherein the one or more projections are positioned to make contact with the cutting element at two or more points along a cutter outside wall surface and to make contact with the cutting element at one or more points along a cutter base surface.
